(19) United States
(12) Patent Application Publication
(10) Pub. No.: US 2024/0193377 A1
(43) Pub. Date: Jun. 13, 2024

(54) PRETRAINING OF SPLIT LAYER PORTIONS FOR MULTILINGUAL MODEL

(71) Applicant: INTERNATIONAL BUSINESS MACHINES CORPORATION, ARMONK, NY (US)

(72) Inventors: LIN PAN, Jersey City, NJ (US); Haode Qi, Cambridge, MA (US); Ladislav Kunc, Cambridge, MA (US); Saloni Potdar, Jersey City, NJ (US)

(21) Appl. No.: 18/063,788

(22) Filed: Dec. 9, 2022

(51) Int. Cl. G06F 40/58

(52) U.S. Cl. CPC G06F 40/58

(57) ABSTRACT

A method, computer system, and a computer program product for training a machine learning model are provided. A machine learning model may be split into a lower portion and an upper portion. The lower portion includes at least one layer. The upper portion includes at least one layer. The lower portion may be pre-trained via a generator task and via alternating between inputting of monolingual text data and multilingual text data. The upper portion may be pre-trained via a discriminator task. The pre-trained lower portion may be joined to the pre-trained upper portion to form a trained multilingual machine learning model.

### BACKGROUND

The present invention relates generally to the field of natural language processing performed by computers and by machine learning models, and more particularly to helping machine learning models more effectively perform natural language processing tasks in response to receiving multilingual input.

### SUMMARY

According to one exemplary embodiment, a method for training a machine learning model is provided. According to the method, a machine learning model may be split into a lower portion and an upper portion. The lower portion includes at least one layer. The upper portion includes at least one layer. The lower portion may be pre-trained via a generator task and via alternating between inputting of monolingual text data and multilingual text data. The upper portion may be pre-trained via a discriminator task. The pre-trained lower portion may be joined to the pre-trained upper portion to form a trained multilingual machine learning model. A computer system and computer program product corresponding to the above method are also disclosed herein.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 is an operational flowchart illustrating a multilingual machine learning model training process according to at least one embodiment;

FIG. 2A illustrates a first portion of a training pipeline for training a multilingual machine learning model using the process shown in FIG. 1 according to at least one embodiment;

FIG. 2B illustrates a second portion of a training pipeline for training a multilingual machine learning model using the process shown in FIG. 1 according to at least one embodiment;

FIG. 2C illustrates a third portion of a training pipeline for training a multilingual machine learning model using the process shown in FIG. 1 according to at least one embodiment;

FIG. 2D illustrates a fourth portion of a training pipeline for training a multilingual machine learning model using the process shown in FIG. 1 according to at least one embodiment;

FIG. 2E illustrates a fifth portion of a training pipeline for training a multilingual machine learning model using the process shown in FIG. 1 according to at least one embodiment;

FIG. 2F illustrates a sixth portion of a training pipeline for training a multilingual machine learning model using the process shown in FIG. 1 according to at least one embodiment; and

FIG. 3 is a block diagram illustrating a computer environment with multiple computer systems in which the multilingual machine learning model training described for FIG. 1 may be performed and/or in which a trained multilingual machine learning model produced using the process of FIG. 1 may be implemented.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The following described exemplary embodiments provide a system, a method, and a computer program product for training a multilingual machine learning model that performs natural language processing. Via the training, the present embodiments have the capacity to create a more powerful multilingual machine learning model that can more accurately and with more efficiency perform a variety of natural language processing tasks based on the applied task-specific output layer. For example, the present embodiments enable sentence pair relationship classification and passage answer extraction to be performed in a more accurate and efficient manner for text input from a variety of languages when the model that is pretrained as described herein is used for those tasks. The present embodiments may enhance automated question and answer programs that could be part of artificial intelligence virtual assistants including multilingual artificial intelligence virtual assistants. The present embodiments may enhance the ability of natural language processing to perform tasks based on a variety of input languages such as English, Spanish, Chinese, etc.

The present embodiments provide a way to enhance the training of the transformer-based multilingual machine learning models so that natural language processing tasks may be performed in a greater variety of languages with more efficiency and accuracy but also without burdensome training requirements for the various languages. The present embodiments build on the understanding that the lower portion of model layers have stored multilingual information that aligns all languages in the embedding space, while upper portions of the model layers have been language-agnostic and task-specific.

The present embodiments split a single pretrained model into two portions, e.g., halves, and train the two split portions separately using different objectives and tasks. The first portion, e.g., the lower portion, is trained as a generator using masking of tokens. The generator fills in the masked tokens with predictions of correct content. The second portion, e.g., the upper portion, receives, as input, the output of the first portion and is trained as a discriminator and detects if each predicted token received from the first portion is the original text that was input or is generator-predicted text that does not match the original text. Instead of discarding the first portion after the pretraining, the trained first portion and the trained second portion are joined together as the trained transformer-based multilingual machine learning model to perform various natural language processing tasks. By keeping the first portion and not discarding the first portion, knowledge gained by the first portion during the pretraining may be advantageously used during implementation of the final or trained machine learning model. During the training of the second portion, during back-propagation the gradient will pass through all tokens instead of the masked tokens only. The examination will be of all of the input tokens, not just the masked tokens. Existing machine learning models as well as untrained machine learning models may be enhanced using the present embodiments. The present embodiments help developers to take an end-to-end approach for retrieving data, training a model, saving the trained model, and implementing the trained model.

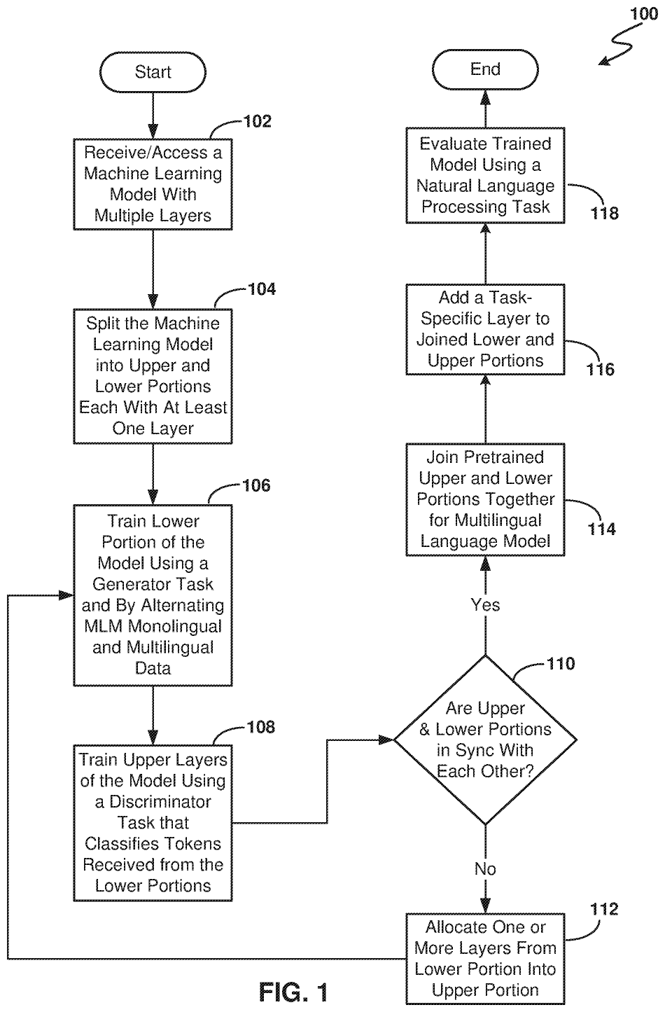

Referring now to FIG. 1, an operational flowchart is shown that illustrates a multilingual machine learning model pretraining process 100 according to at least one embodiment.

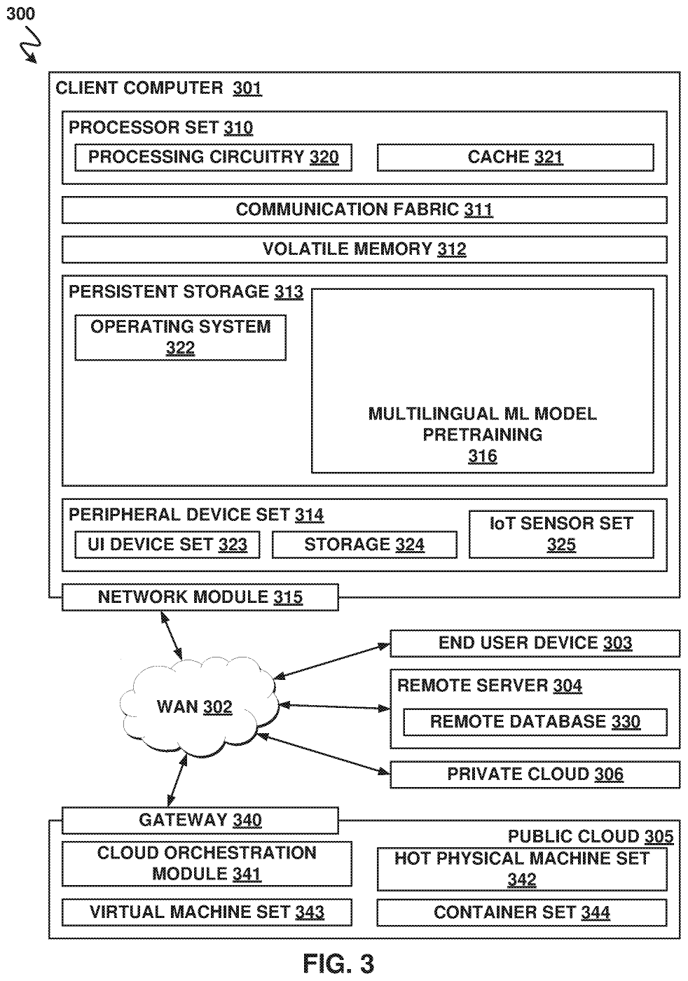

In step 102 of the multilingual machine learning model pretraining process 100 shown in FIG. 1, a machine learning model with multiple layers is received and/or accessed. This machine learning model may be accessed and/or received via a computer such as the client computer 301 shown in FIG. 3 which includes the multilingual machine learning model pretraining program 316. The machine learning model may be transmitted via a data transmission over the network 302. The machine learning model may also be disposed in a remote computer such as the remote server 304 and/or end user device 303 and accessed via a data transmission from the client computer 301.

The machine learning model that is received and/or accessed in step 102 has multiple layers meaning at least two layers. In some embodiments, the machine learning model has six layers, eight layers, twelve layers, or some other number of multiple layers.

A transformer is a deep learning model that adopts the mechanism of self-attention. The self-attention is implemented by differentially weighting the significance of each part of the input data. Transformers are designed to process sequential input data, such as natural language, with applications towards a variety of natural language processing tasks. Unlike recurrent neural networks, transformers process the entire input all at once. The attention mechanism provides context for any position in the input sequence. For example, if the input data is a natural language sentence, the transformer does not have to process one word at a time. This use of self-attention allows for increased parallelization and, therefore, reduced training times. The additional training parallelization allows training on larger datasets such as is available with a more popular language such as English versus a language used by a smaller population base. Attention mechanisms let a model draw from the state at any preceding point along the sequence. The attention layer can access all previous states and weight them according to a learned measure of relevance, providing relevant information about far-away tokens. Transformers use an attention mechanism without an RNN, processing all tokens at the same time and calculating attention weights between them in successive layers. Since the attention mechanism only uses information about other tokens from lower layers, it can be computed for all tokens in parallel, which leads to improved training speed.

In at least some embodiments, input data such as input text is parsed into tokens by a byte pair encoding tokenizer that is for or part of the transformer that is the machine learning model accessed and/or received in step 102. A tokenizer breaks unstructured data and natural language text into chunks of information that can be considered as discrete elements. The token occurrences in a text body may be used as a vector representing the word. Through this tokenization, an unstructured string is converted into a numerical data structure that is more suitable for analysis in machine learning. Each token is converted via a word embedding into a vector. Positional information of the token is added to the word embedding. Some embodiments may include transformers with an encoder-decoder architecture. The encoder includes encoding layers that process the input iteratively one layer after another. The decoder includes decoding layers that do the same thing to the output of the encoder. The function of each encoder layer is to generate encodings that contain information about which parts of the inputs are relevant to each other. A layer passes its encodings as inputs to the next encoder layer. Each decoder layer does the opposite, taking all the encodings and using their incorporated contextual information to generate an output sequence. To achieve this, each encoder and decoder layer makes use of an attention mechanism. For each part of the input, attention weighs the relevance of every other part and draws from those weights to produce the output. Each decoder layer may have an additional attention mechanism that draws information from the outputs of previous decoders before the decoder layer draws information from the encodings. Both the encoder and decoder layers may be implemented in a feed-forward neural network for additional processing of the outputs and may contain residual connections and layer normalization steps. The transformer building blocks are scaled dot-product attention units. When a sentence is passed into a transformer model, attention weights are calculated between every token simultaneously. The attention unit produces embeddings for every token in context that contain information about the token itself along with a weighted combination of other relevant tokens each weighted by its attention weight.

The machine learning model that is received and/or accessed in step 102 may already be pre-trained at the time of step 102, may be partially trained at the time of step 102, or may be untrained at the time of step 102.

In step 104 of the multilingual machine learning model pretraining process 100 shown in FIG. 1, the machine learning model is split into upper and lower portions each with at least one layer. This machine learning model that is split is the machine learning model that was received and/or accessed in step 102. This splitting of step 104 may be performed via the multilingual machine learning model pretraining program 316, in an automated manner, analyzing programming code of the machine learning model, identifying linking code between different code portions that perform the layers, and extracting the layers for the upper portion and/or for the lower portion at the linking code. The programming code may be in one of a variety of programming languages. In other embodiments, a programmer uses the client computer 301 to perform the above-mentioned code analysis, linking code identification, and portion extracting at the linking code. The various layers may in some embodiments be represented respectively in different parts of the programming code. Such different code areas may in at least some embodiments be joined together via programming connectors such as loops. Different layers of the machine learning model may be joined together via a respective loop.

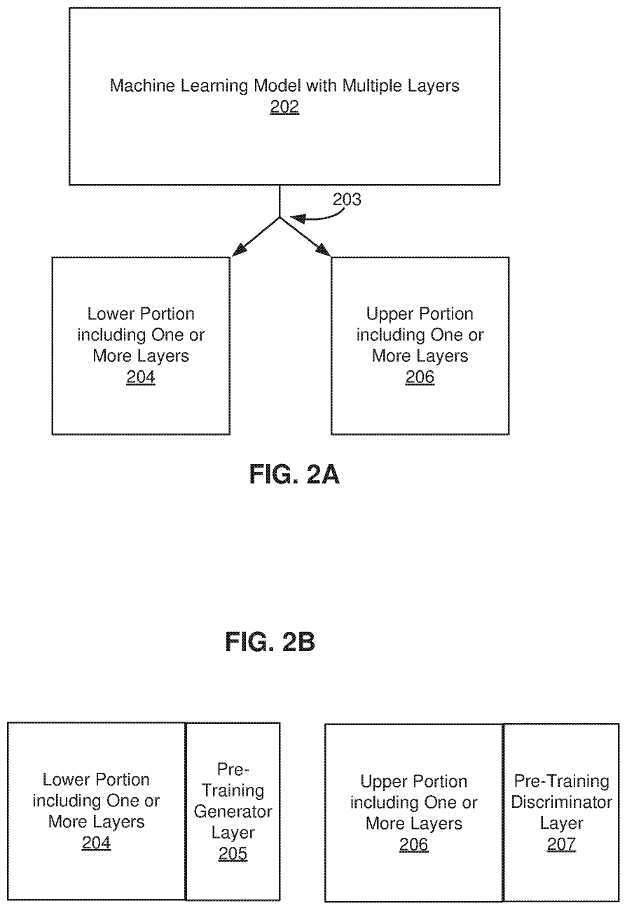

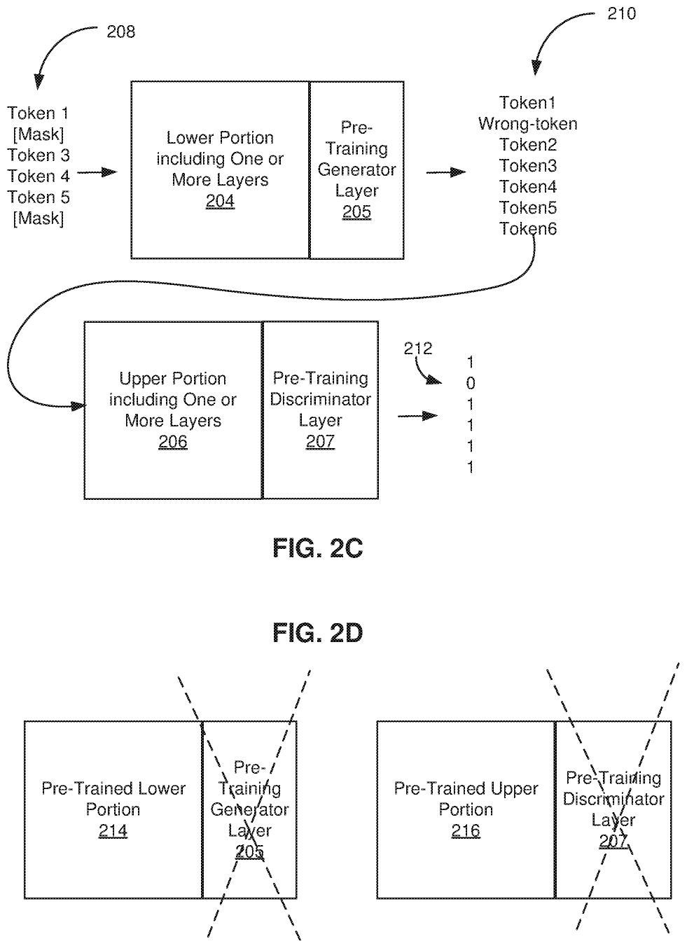

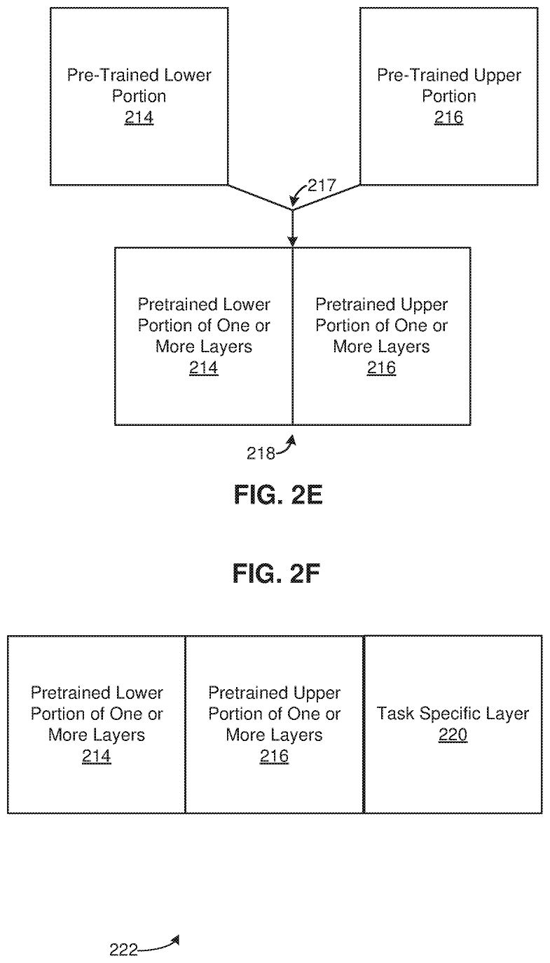

FIG. 2A illustrates the step 102 by showing that the machine learning model 202 that has multiple layers is, via a splitting step 203, split into (1) the lower portion 204 that includes one or more layers and (2) the upper portion 206 that includes one or more layers. Due to this splitting, some layers of the machine learning model 202 end up in the lower portion 204 and other layers of the machine learning model 202 end up in the upper portion 206. As explained above, the multilingual machine learning model pretraining program 316 in an automated manner and/or a computer programmer using the program 316 and the computer 301 may perform the splitting step 203.

In step 106 of the multilingual machine learning model pretraining process 100 shown in FIG. 1, the lower portion is trained using a generator task and by alternating between masking with monolingual training data and multilingual training data. This lower portion was in step 104 split out from the machine learning model that was received and/or accessed in step 102. To perform this pretraining of step 106, as is depicted in FIG. 2B a pre-training generator layer 205 is added to the lower portion. This generator layer 205 may be a layer of code which is added on to the code of the lower portion 204.

Whether for the monolingual training data or for the multilingual training data, the generator task may include analyzing masked portions of the monolingual text data and masked portions of the multilingual text data and predicting, via the lower portion, content of the masked portions. As is shown in FIG. 2C a tokenizer that is part of the lower portion 204 or is established before the lower portion 204 may receive text data and generate tokens from the text data. In order to train the lower portion 204 to be familiarized with certain word combinations, the tokenizer or another module masks some of the tokens to create a token set 208 with some masks over some of the tokens. Some of the tokens are selected for masking on a random basis based on their position in the chain of tokens. For example, in the depicted token set 208 a text group, e.g., a sentence, with six members, e.g., words, was input to the tokenizer, tokens were generated for each of the members, and masks were placed over the second and sixth members of the group. The token set 208 in the depicted embodiment, specifically includes the members Token 1, a first mask, Token 3, Token 4, Token 5, and a second mask.

To illustrate the masking with actual text input, one example is provided with the sentence “The long table sits eight people.” being input into the tokenizer. Tokens are generated for each of those six words, but a first mask is placed over the token for the second word “long” and a second mask is placed over the token for the sixth word “people”. The lower portion 204 is expected to study the context of the word groups and together with the pre-training generator layer 205 predict what respective word or words belongs in each masked position.

For example, the lower portion 204/predictor layer 205 pair is expected to study the token set 208 which in one embodiment is “The [mask] table sits eight [mask].” and predict which word or words belong in each of the masked positions. The lower portion 204 and the pre-training generator layer 205 together produce a prediction-containing output set 210 which includes predictions for the masked portions. For example, based on the input the of the above-described example of “The [mask] table sits eight [mask].” the lower portion 204/pre-training generator layer 205 pair may predict a prediction-containing output set 210 of “The dining table sits eight people.” The pair predicted a token representing the word “dining” for the second spot and another token representing the word “people” for the sixth spot. The exemplary prediction-containing output set 210 shows for illustrative purposes that the second spot has a “Wrong-token” indicator, because the original input included the word “long” in the second spot and the prediction was for “dining” in the second spot. The showing of “Wrong-token” in the second spot in FIG. 2C is illustrative because in implementation at this stage neither the lower portion 204/generator layer 205 pair nor the upper portion 206/discriminator layer 207 pair knows that the prediction of “The dining table sits eight people.” is incorrect for the second position (“dining”).

As will be described for step 108, the prediction-containing output set 210 is input into the upper portion 206/discriminator layer 207 pair for the pre-training of the upper portion 206. The upper portion 206 is predicted to train whether each of the portions of the prediction-containing output set 210 is correct.

The training of the lower portion 204 also includes inputting multilingual text data into the lower portion 204 and not only the monolingual text data. This multilingual text data may be referred to as parallel data. The parallel data may include text of a first language and a translation of that text into an additional language. In various embodiments, the other language translation text is connected to the first language text, e.g. is concatenated to the first language text, so that the multilingual text data is submitted in this connected form to the portions for the training. Thus, a length-increased text group is used to train the lower portion 204, with the length-increased text group having a first portion which says a statement in a first language followed by the same statement but in a second language. The use of this type of parallel data injects explicit cross-lingual knowledge into the lower portion of the layers. This injection is performed still using masked terms and prediction of the masked terms as the training objective. The multilingual text data in training has been referred to in other instances as translation language modeling. The multilingual text data may connect a variety of languages such as languages that are more widely spoken such as English and other languages used by a smaller population base.

In one example of the training using the multilingual parallel data, a first text portion of the multilingual parallel data is provided in a first language as “A house rule is no eating food on the sofa”. A translation of this statement into a second language is a second text portion of the multilingual parallel data. In one example, the second language is German and the second text portion is “Eine Hausregel ist, auf dem Sofa nichts zu essen.” The second text portion is connected, e.g. concatenated, to the first portion to create multilingual parallel text data which is increased in length compared to monolingual data for the same statement. The connection for the above example would result in the increased length text input of “A house rule is no eating food on the sofa. Eine Hausregel ist, auf dem Sofa nichts zu essen.” being input to train the lower portion 204. This lengthened input may be submitted to the tokenizer which produces tokens for each of the words. In some embodiments, additional tokens are also generated for the beginning and end of each sentence. Thus, the increased length text input may generate a token set of twenty-three tokens, with a lead token for the English portion, ten tokens for the ten words of the English sentence, an end token for the English sentence a lead token for the German sentence, nine tokens for the nine words of the German sentence, and an end token for the German sentence (1+10+1+1+9+1=23).

Masks may be generated randomly over the various positions, e.g., of the positions representing a respective word, of the multilingual text input. In some embodiments, at least one token from the first portion (in the first language) is masked and at least one token from the second portion (in the second language) is masked. For example, the token set corresponding to the token set 208 but for the multilingual text input may be tokens representing the words “A [mask] rule is no [mask] food on the [mask]. Eine Hausregel ist, [mask] dem [mask] nichts zu essen.” Thus, the masked token set for the representation of this parallel data may be token 1 (/s), token 2 (A), [mask], token 4 (rule), token 5 (is), token 6 (no), [mask], token 8 (food), token 9 (on), token 10 (the), [mask], token 12 (/s), token 13 (/s), token 14 (Eine), token 15 (Hausregel), token 16 (ist), [mask], token 18 (dem), mask, token 20 (nichts), token 21 (zu), token 22 (essen), token 23 (/s).

In response to the above masked token set being input into the lower portion 204/generator layer 205 pair, the lower portion 204/generator layer 205 pair may predict the masked portions as “house”, “eating”, “carpet”, “auf”, “Teppich”. Thus, in this example the lower portion 204/generator layer 205 pair correctly predicts three out of five masked portions correctly. The prediction-containing output set 210 for this multilingual text input would, using the format shown in FIG. 2C, be: Token 1, Token 2, Token 3, Token 4, Token 5, Token 6, Token 7, Token 8, Token 9, Token 10, Wrong-token, Token 12, Token 13, Token 14, Token 15, Token 16. Token 17, Token 18, Token 19, Wrong-token, Token 21, Token 22, Token 23. As will be explained further with respect to step 108, this prediction-containing output set is input into the upper portion 206/discriminator layer 207 pair to train this upper portion 206 to correctly predict whether each word in the input data set correctly belongs to the set or was mis-predicted by the lower portion 204/generator layer 205 pair. In some embodiments, the multilingual text data always includes at least one set of English-language text amongst the text portions joined to each other. In some embodiments, the multilingual text data always includes a first portion of text in a first language and a second portion of text in a second language that is a translation of the first portion text. During the pre-training in step 106, the second language selected for various second portions of different text data inputs for the training may vary between a variety of second languages while the first language remains constant throughout the training in step 106.

The alternation in the pre-training of step 106 of the masked token prediction task between (1) monolingual text data and (2) multilingual text data helps avoid catastrophic forgetting of language-specific information. This alternation may be performed in a variety of amounts of text data of the monolingual text data and of the multilingual text data. For example, the alternation could occur with amounts of monolingual text data exceeding the amounts of multilingual text data that are used. Alternatively, the alternation could occur with amounts of multilingual text data exceeding the amounts of monolingual text data that are used. The alternation could occur in many turns taken back and forth between the two types. The alternation could occur in large sets with few large sets of the first type and one or a few sets of the other type interspersed between those of the first type. In a simple version, the alternation could be one large set of monolingual data followed by one set of the multilingual text data.

The training of step 106 may include large sets of text data being input into the lower portion 204/generator layer 205 pair in order to provide a thorough training of the lower portion 204. The multilingual data may include text data from two languages or from more than two languages. Translated text databases may be accessed by the multilingual machine learning model pretraining program 516 to obtain training text data to input to the lower portion 204 to train the lower portion 204 as a part of step 106. The multilingual machine learning model pretraining program 516 may access translated text databases with already connected text data or may itself generate and connect the text data for preparing to pre-train the machine learning model.

In step 108 of the multilingual machine learning model pretraining process 100 shown in FIG. 1, upper layers of the multilingual machine learning model are trained using a discriminator task that classifies tokens received from the lower portions. This multilingual machine learning model also refers to the model that is received and/or accessed in step 102 and that was split in step 104. The lower portions refers to those portions that are trained in step 106. The set of tokens with lower portion 204-generated predictions filling in the masks is fed as a corrupted or potentially-corrupted text into the upper portion 206 of the layers. The training objective in performing the discriminator task is for the one or more upper layers to classify each token generated by the lower layers as original text or as noisy text that was generated by the lower layers. Noisy text refers to a word or token which the upper portion believes was predicted incorrectly by the lower portion. This classification of the received output from the lower portion may be referred to as validating the tokens predicted by the lower portion. Because the sets with predicted portions include the multilingual text data, in this manner, some language-specific knowledge is injected into the one or more upper layers so that these one or more upper layers are no longer completely language agnostic. Because an entire set of tokens is sent for evaluation to the upper portion 206, the upper portion 206 is trained over all of the tokens and not only a sub-set of the tokens. The upper portion 206 does not know of the received prediction-containing token set 210 which of the tokens constitutes a prediction and which token was for a word of the original text. This allows all tokens to be efficiently used as a gradient will pass though all of the tokens in the set during backpropagation. This use of all of the tokens allows enhanced training for the model with a reduced amount of training data needed. The upper portion is required to make a judgment for each of the received tokens and not only for the masked tokens.

FIG. 2C shows an example of step 108 occurring in that the prediction-containing output set 210 is input into the upper portion 206/discriminator layer 207 pair. Although the prediction-containing output set 210 is shown with the second token labeled as “Wrong-token”, in implementation the actual predicted token (representing a word) is included in this second place and the upper portion 206/discriminator layer 207 pair is not initially informed which of the tokens was wrongly predicted. Rather, the task of the upper portion 206/discriminator layer 207 pair is to itself predict and/or determine which of the tokens in the set is correct and which was falsely predicted. The upper portion 206/discriminator layer 207 pair may produce a binary decision for each token indicating whether the upper portion 206/discriminator layer 207 pair predicts a particular token as being part of the original text or as being noisy text. In some embodiments a binary indicator for the original text prediction is “1” and a binary indicator for the noisy text prediction is “0”. In the example shown the upper portion discriminator prediction set 212 is “1, 0, 1, 1, 1, 1” meaning that the upper portion 206 predicts that the first and second through sixth tokens correspond to the original text but that the second token is a mis-prediction that was not part of the original text. This example of the upper portion discriminator prediction set 212 is “1, 0, 1, 1, 1, 1” is provided for illustrated purposes to show an example where the upper portion 206/discriminator layer 207 pair correctly recognized that the second position token predicted by the lower portion 204/generator layer 205 pair was incorrect. With the prediction-containing output set 210 of the example Original Text—“The long table sits eight people.” and the predicted tokens of “The dining table sits eight people.”, the upper portion 206/discriminator layer 207 pair may correctly analyze that the prediction of a token representing the word “dining” in the second spot was incorrect and should have been a token representing the word “long”. In practice, sometimes the upper portion 206/discriminator layer 207 pair may itself misjudge whether a predicted token was part of original text or was noisy text. In other instances or in other stages of the pretraining the upper portion 206/discriminator layer 207 pair may believe that the prediction was correct and may provide the upper portion discriminator prediction set 212 of “1, 1, 1, 1, 1, 1” because they believe that every word was part of original text. Alternatively, the upper portion 206/discriminator layer 207 may in some instances provide an upper portion discriminator prediction set 212 of “1, 1, 1, 1, 0, 1” because the upper portion 206 predicts that the original text would have included some other word instead of “eight”.

Similar upper portion discriminator prediction sets 212 would be generated for the prediction-containing token sets 210 from the multilingual training data.

In step 110 of the multilingual machine learning model pretraining process 100 shown in FIG. 1, a determination is made whether the upper and lower portions are in sync with each other. The upper portion refers to the portion and one or more layers that were and/or are being trained in step 108. The lower portion refers to the portion and one or more layers that were and/or are being trained in step 106. If the determination of step 110 is affirmative and the upper and lower portions are in sync, the multilingual machine learning model pretraining process 100 may proceed to step 114 and skip step 112. If the determination of step 110 is negative and the upper and lower portions are not in sync, the multilingual machine learning model pretraining process 100 proceeds to step 112.

If the lower portion 204 becomes too effective via the pre-training, it becomes more difficult for the upper portion 206 of the overall model to learn. Thus, the syncing check of step 110 is carried out to prevent this block of upper model learning from happening. In some instances, the determination of step 110 occurs by evaluating a successful prediction rate of the lower portion 204/generator layer 205 pair. The multilingual machine learning model pretraining program 316 is, for step 110, input the original text as part of supervised training. The multilingual machine learning model pretraining program 316 compares the original text to the predictions, e.g., to the prediction-containing token set 210, to determine a prediction accuracy of the lower portion 204/generator layer 205 pair. If the prediction accuracy exceeds a pre-determined threshold, the multilingual machine learning model pretraining program 316 will consider the lower and upper portions to be out of sync. This pre-determined threshold may in some embodiments be a 90% accuracy.

In step 112 of the multilingual machine learning model pretraining process 100 shown in FIG. 1, one or more layers from the lower portion are allocated into the upper portion. For example, in an embodiment in which the lower portion 204 initially includes six layers and the upper portion 206 initially includes six layers, one or more layers may be taken from the lower portion 204 and reallocated to the upper portion 206. Thus, if one layer is reallocated then thereafter in this embodiment the lower portion 204 includes five total layers and the upper portion 206 includes seven total layers. If two layers are reallocated then thereafter in this embodiment the lower portion 204 includes four total layers and the upper portion 206 includes eight total layers. The reallocation of a layer may occur via the multilingual machine learning model pretraining program 316 and/or a programmer using the program 316 on the computer 101 extracting code representing the particular layer and moving this code to the code group of the upper portion layers. The extracted layer may be attached in a front position or mid-position of the code group representing the upper portion. This reallocation may help bring training of the lower portion 204 and the upper portion 206 back in sync so that the upper portion 206 is given a better chance to learn and identify some errors. If the lower portion 204 learns so quickly that the lower portion 204 produces few or no errors in the prediction, it will be harder for the upper portion 206 to be trained well to identify errors.

These steps of 110 and 112 may be performed in response to dissatisfaction with performance of the trained model. In response to this reallocation of step 112, then the steps 106 and 108 to train the lower and upper portions may be repeated after the reallocation. This repeating is indicated by the outflow edge of step 112 leading back to step 206 for a repeat of steps 106, 108, and 110.

In another embodiment, an alternative approach may be implemented to avoid the lower portions becoming out of sync with the upper portions. In this alternative approach, a loss function for the full model is weighted more heavily for the discriminator portion than for the generative portion. For example, the loss function for the model in one embodiment is Ltotal=Ldiscriminator*w1+Lgenerator*w2 with w1 and w2 being weights and w1 being larger, e.g., substantially larger, than w2. For example, the weight w1 may be at least double the size of the weight w2, e.g., with w2 being 0.4 and w1 being 0.8 or higher. In one embodiment, the w1 would be twenty times greater than w2 with w1 being 20.0 and w2 being 1.0. In this alternative the strategic weighting helps proactively prevent the lower portion training from overpowering the upper portion training.

The training of the lower portion in step 104 and of the upper portion in step 106 may occur with using one or more optimizers for each portion of the model. For example, in some embodiments two optimizers are used for the pre-training of the lower portion and two optimizers are used for the pre-training of the upper portion. Using the correct text data, the optimization for the upper portion may include backpropagation with a gradient passing through all of the tokens in the prediction-containing token set 210. The optimizers may implement a loss function as a way of measuring the difference between the original data and the portion-predicted data. By minimizing the degree of error of the loss function, the aim is to make the model more accurate when predicting outcomes and/or classifying data points. The optimizing functions may include adjusting hyperparameters and/or node weights in the layers in order to choose those hyperparameters and/or node weights which minimize the loss. The optimizers may, for example, include techniques of gradient descent, Fibonacci search, line search, evolution algorithms, Bayesian optimization, and/or random searches.

In step 114 of the multilingual machine learning model pretraining process 100 shown in FIG. 1, the pretrained upper and lower portions are joined together for the multilingual machine learning model. The lower portion is pre-trained in step 104 described above and produces a pre-trained lower portion 214 as is shown in FIG. 2D. The upper portion is pre-trained in step 106 described above and produces a pre-trained upper portion 216 as is shown in FIG. 2D.

In preparation for step 114, after completion of the pre-training in step 104 the pre-training generator layer 205 is removed from the pre-trained lower portion 214. Also in preparation for step 114, after completion of the pre-training in step 106 the pre-training discriminator layer 207 is removed from the pre-trained upper portion 216. This layer removal may occur via the multilingual machine learning model pretraining program 316 and/or a programmer using the program 316 on the computer 101 identifying and removing the code that represents the generator layer 205 and identifying and removing the code that represents the discriminator layer 207.

To perform step 114, the multilingual machine learning model pretraining program 316 and/or a programmer using the program 316 on the computer 101 reattaches the code representing the pre-trained lower portion 214 to the code representing the pre-trained upper portion 216. The code is reattached in a manner so that output produced by the final layer of the pre-trained lower portion 214 is input into a first layer of the pre-trained upper portion 216. In this manner the layers of the upper portion are positioned to receive output from the lower portion in the trained multilingual machine learning model. This code reattachment is illustrated in FIG. 2E with the joining action arrow 217.

FIG. 2E illustrates aspects of the step 114 of joining the pretrained upper and lower portions together. FIG. 2E shows a trained multilingual machine learning model 218 that was produced using the process shown in FIG. 1 and by the joining of the pre-trained lower portion 215 to the pre-trained upper portion 216 via a joining action 217. The trained multilingual machine learning model 218 includes the pretrained lower portion 214 and the pretrained upper portion 216. The two portions are positioned so that an output of the pretrained lower portion 214 is input into a first layer of the pretrained upper portion 216.

In step 116 of the multilingual machine learning model pretraining process 100 shown in FIG. 1, a task-specific layer is added to the joined lower and upper portions. The joined upper and lower portions were produced in the step 114. FIG. 2F illustrates an example of a task-modified multilingual machine learning model 222 which includes a task-specific layer 220 that is added to the trained multilingual machine learning model 218. Thus, the task-modified multilingual machine learning model 222 includes the pretrained lower portion 214, the pretrained upper portion 216, and the task-specific layer 220. The task-specific layer 220 is added to the trained multilingual machine learning model 218 so as to receive output from a last layer of the pretrained upper portion 216 and to produce a task-specific response to that output from the last layer of the pretrained upper portion 216. This layer addition may occur via the multilingual machine learning model pretraining program 316 and/or a programmer using the program 316 on the computer 101 adding task-specific coding to the code that represents the pretrained upper portion 216.

The task-specific layer 220 may in some embodiments be configured to perform, in conjunction with the pretrained lower portion and the pretrained upper portion, a natural language processing task such as a text sequence classification task and or question answering. The sequence classification task may include sentence pair relationship classification in which pairs of sentences are input into the task-modified multilingual machine learning model 222 and the task-modified multilingual machine learning model 222 outputs a sentence pair relationship classification with classes of entailment, contradiction, and neutral. In some embodiments, the natural language processing task may be question answering in which a question and a body of text, i.e., a text passage, containing an answer to the question are input into the task-modified multilingual machine learning model 222. In response, the task-modified multilingual machine learning model 222 finds the answer within the body of the text and gives as output the answer. This question answering text is helpful for improving the function of automated chatbots which interact with persons seeking questions. With this question and answer, given a question and a passage that are input into the trained model, the trained model extracts a text span from the passage that contains an answer to the question. An evaluation dataset may be applied for this extracting of question and answer that covers multiple languages, e.g., that covers seven different languages.

In step 118 of the multilingual machine learning model pretraining process 100 shown in FIG. 1, the trained model is evaluated using a natural language processing task. This model that is evaluated refers to the model formed via the previous steps of 104, 106, 108, 110, possibly 112, 114, and 116. The effectiveness of the task-modified multilingual machine learning model 222 may in step 118 be determined and compared to the effectiveness of other types of natural language processing models.

In some embodiments, the evaluation is performed with evaluation settings for zero-shot cross-lingual transfer or using a translate train. The use of a translated second language portion in the multilingual data described above does not remove the multilingual machine learning model pretraining process 100 from being able to be evaluated with zero-shot cross-lingual transfer.

In the zero-shot cross-lingual transfer, the upper and lower portions are trained in the multilingual machine learning model pretraining process 100 on a first-language data set. Thereafter, text data that is used for the evaluation in step 118 comes exclusively from another language. For example if the first language in the training was English, the training data may come from a second non-English language such as German, Spanish, or Chinese. The German-language text data, Spanish-language text data, or Chinese-language text data are input without the English-language data set into the trained model to check for performance of a natural language processing task.

In the translate train evaluation setting, the initial training is done with a first-language text data set, that text data set is translated into one or more other languages, and thereafter the text data set for the one or more other languages is used as the basis for training a new or the same machine learning model.

After step 118, the multilingual machine learning model pretraining process 100 may end. The trained model may be used to perform a variety of natural language processing tasks in which text input is received and the model provides a text output which is an answer and/or a solution.

It may be appreciated that FIGS. 1, 2A, 2B, 2C, 2D, 2E, and 2F provide only illustration of certain embodiments and do not imply any limitations with regard to how different embodiments may be implemented. Many modifications to the depicted embodiment(s), e.g., to a sequence of steps or components that are depicted, may be made based on design and implementation requirements.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 shown in FIG. 3 contains an example of an environment for the execution of at least some of the computer code involved in performing the inventive methods, such as multilingual machine learning model pretraining 316. In addition to multilingual machine learning model pretraining 316, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and multilingual machine learning model pretraining 316, as identified above), peripheral device set 314 (including user interface (UI) device set 323, storage 324, and Internet of Things (IOT) sensor set 325), and network module 315. Remote server 304 includes remote database 330. Public cloud 305 includes gateway 340, cloud orchestration module 341, host physical machine set 342, virtual machine set 343, and container set 344.

COMPUTER 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

PROCESSOR SET 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in multilingual machine learning model pretraining 316 in persistent storage 313.

COMMUNICATION FABRIC 311 is the signal conduction path that allows the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

PERSISTENT STORAGE 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in multilingual machine learning model pretraining 316 typically includes at least some of the computer code involved in performing the inventive methods.

PERIPHERAL DEVICE SET 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments. UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

NETWORK MODULE 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 303 is any computer system that is used and controlled by an end user (for example, a customer of an enterprise that operates computer 301) and may take any of the forms discussed above in connection with computer 301. EUD 303 typically receives helpful and useful data from the operations of computer 301. For example, in a hypothetical case where computer 301 is designed to provide a natural language processing result to an end user, this result would typically be communicated from network module 315 of computer 301 through WAN 302 to EUD 303. In this way, EUD 303 can display, or otherwise present, the result to an end user. In some embodiments, EUD 303 may be a client device, such as thin client, heavy client, mainframe computer, desktop computer and so on.

REMOTE SERVER 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

PUBLIC CLOUD 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for training a machine learning model, the method comprising:
splitting a machine learning model into a lower portion and an upper portion, the lower portion comprising at least one layer, the upper portion comprising at least one layer;
pre-training the lower portion via a generator task and via alternating between inputting of monolingual text data and multilingual text data;
pre-training the upper portion via a discriminator task; and
joining the pre-trained lower portion to the pre-trained upper portion to form a trained multilingual machine learning model.

2. The method of claim 1, wherein the pre-training of the upper portion via the discriminator task comprises:
receiving output from the lower portion performing the generator task during the pre-training of the lower portion, and
performing classification of the received output.

3. The method of claim 2, wherein classes for the classification are selected from a group consisting of original data and noisy data.

4. The method of claim 1, wherein the pre-training of the upper portion via the discriminator task comprises applying a gradient that, during back-propagation, passes through all tokens generated by the lower portion.

5. The method of claim 1, wherein the discriminator task comprises validating tokens predicted by the lower portion.

6. The method of claim 1, wherein the multilingual text data comprises a first portion and a second portion, the first portion comprising first text in a first language, the second portion comprising second text that is a translation of the first text into a second language.

7. The method of claim 1, further comprising:
evaluating a performance of the pre-trained lower portion; and
in response to the evaluation, reallocating a distribution of the layers between the lower portion and the upper portion.

8. The method of claim 7, wherein the reallocating comprises giving one or more layers of the lower portion to the upper portion.

9. The method of claim 7, wherein the reallocating is performed in response to the evaluation indicating that performance of the lower portion for the generator task exceeds a pre-determined threshold.

10. The method of claim 1, wherein the trained multilingual machine learning model is configured to perform a sequence classification task comprising sentence pair relationship classification.

11. The method of claim 10, wherein classes for the sentence pair relationship classification are selected from a group consisting of an entailment, a contradiction, and neutral.

12. The method of claim 1, wherein the trained multilingual machine learning model is configured to perform a natural language processing task comprising providing an answer in response to receiving a question and in response to receiving a text passage that comprises the answer.

13. The method of claim 1, further comprising:
adding a generator layer to the lower portion for the performing of the generator task of the pre-training of the lower portion; and
removing the generator layer from the pre-trained lower portion before the joining of the pre-trained lower portion to the pre-trained upper portion to form the trained multilingual machine learning model.

14. The method of claim 1, further comprising:
adding a discriminator layer to the upper portion for the performing of the discriminator task of the pre-training of the upper portion; and
removing the discriminator layer from the pre-trained upper portion before the joining of the pre-trained lower portion to the pre-trained upper portion to form the trained multilingual machine learning model.

15. The method of claim 1, further comprising adding a task-specific layer to the joined pre-trained lower and upper portions to form the trained multilingual machine learning model, wherein the task-specific layer is added to the joined pre-trained lower and upper portions so as to receive output from the pre-trained upper portion.

16. The method of claim 1, wherein the joining of the pre-trained lower portion to the pre-trained upper portion comprises the pre-trained upper portion being positioned to receive output from the pre-trained lower portion as part of the trained multilingual machine learning model.

17. The method of claim 1, wherein the machine learning model that is split comprises a transformer that implements self-attention.

18. The method of claim 1, wherein the pre-training of the lower portion via the generator task comprises:
masking portions of the monolingual text data and of the multilingual text data; and
predicting, via the lower portion, content of the masked portions.

19. A computer system for training a multilingual machine learning model that performs natural language processing, the computer system comprising:
one or more processors, one or more computer-readable memories, one or more computer-readable tangible storage media, and program instructions stored on at least one of the one or more computer-readable tangible storage media for execution by at least one of the one or more processors via at least one of the one or more computer-readable memories to cause the computer system to:
split a machine learning model into a lower portion and an upper portion, the lower portion comprising at least one layer, the upper portion comprising at least one layer;
pre-train the lower portion via a generator task and via alternating between inputting of monolingual text data and multilingual text data;
pre-train the upper portion via a discriminator task; and
join the pre-trained lower portion to the pre-trained upper portion to form a trained multilingual machine learning model.

20. A computer program product for training a multilingual machine learning model that performs natural language processing, the computer program product comprising a computer-readable storage medium having program instructions embodied therewith, wherein the program instructions are executable by a processor to cause the processor to perform a method comprising:
split a machine learning model into a lower portion and an upper portion, the lower portion comprising at least one layer, the upper portion comprising at least one layer;
pre-train the lower portion via a generator task and via alternating between inputting of monolingual text data and multilingual text data;
pre-train the upper portion via a discriminator task; and
join the pre-trained lower portion to the pre-trained upper portion to form a trained multilingual machine learning model.
